(19) United States
(12) Patent Application Publication
(10) Pub. No.: US 2021/0127349 A1
(43) Pub. Date: Apr. 29, 2021

(54) PROVIDING USER EQUIPMENT (UE) LOCATION INFORMATION TO A UE MONITORING NODE

(71) Applicant: Telefonaktiebolaget LM Ericsson (publ), Stockholm (SE)

(72) Inventor: Wenliang XU, Shanghai (CN)

(73) Assignee: Telefonaktiebolaget LM Ericsson (publ), Stockholm (SE)

(21) Appl. No.: 15/734,676

(22) PCT Filed: Jun. 5, 2018
(86) PCT No.: PCT/CN2018/089859

§ 371 Date: Dec. 3, 2020

(51) Int. Cl. H04W 64/00; H04W 48/16; H04W 24/08; H04W 76/11; H04W 60/04; H04W 8/08

(52) U.S. Cl. CPC H04W 64/006; H04W 48/16; H04W 8/08; H04W 76/11; H04W 60/04; H04W 24/08

(57) ABSTRACT

A monitoring node (MN) may wish to receive a location report whenever a particular UE (or any UE included in a particular group of UEs) enters a specific geographic area (e.g., a city, a neighborhood, a street, etc.) specified by the MN. Accordingly, in one aspect there is provided a method for providing location information to the MN. In one embodiment, the method includes an exposure function (EF) receiving a request message transmitted by the MN, the request comprising an ID identifying at least one UE, and further comprising GAI defining a geographic area, wherein the request message requests that the monitoring node be provided with a notification when it has been discovered that any UE identified by the ID has moved into (or out of) the geographic area.

### TECHNICAL FIELD

Disclosed are embodiments related to providing UE location information to a UE monitoring node.

### BACKGROUND

A 3GPP 4G network (a.k.a., Long Term Evolution (LTE) network) includes an exposure function (referred to as Service Capability Exposure Function (SCEF)) that enables a non-3GPP application (e.g., a Service Capabilities Sever (SCS), an application server (AS), etc.) to obtain location information concerning a particular user equipment (UE) or any UE included in a particular group of UEs. As used herein, a UE is a mobile communication device (e.g., smartphone, tablet, mobile sensor, etc.) whose general location can be determined by a network (e.g., a 3GPP 4G network, a 3GPP 5G network, etc.).

For example, the SCEF can be configured to provide to a monitoring node (e.g., an SCS/AS) location information for a UE, wherein the location information identifies the UE's current location or the UE's last known location. For instance, the monitoring node can send to the SCEF a request for the UE's location information and the SCEF can be configured to respond to the request by transmitting to the monitoring node information identifying the UE's current location or last known location.

### SUMMARY

A monitoring node may wish to receive a location report whenever a particular UE (or any UE included in a particular group of UEs) enters a specific geographic area (e.g., a city, a neighborhood, a street, etc.) specified by the monitoring node. But the conventional exposure function does not support such a feature. This disclosure describes, among other things, ways in which such UE location information can be provided to the monitoring node.

For example, in one aspect there is provided a method for providing UE location information to a UE monitoring node. In one embodiment, the method includes an exposure function receiving a first request message transmitted by the monitoring node, the first request message comprising an ID identifying either a single UE or a group of UEs, and further comprising geographic area information (GM) defining an geographic area, wherein the request message requests that the monitoring node be provided with a notification when it has been discovered that any UE identified by the ID has moved into (or out of) the geographic area. In response to receiving the first request message, the exposure function generates presence reporting area information (PRAI) based on the GM, wherein the PRAT comprises a set of one or more area identifiers and then transmits to a subscriber data function a second request message comprising the ID and the PRAI.

An advantage of the above described method is that it enables a monitoring node to request that the exposure function to provide to the monitoring node a notification whenever the exposure function discovers that a UE identified by the ID moves into (or out of) the geographic area. This not only greatly enriches location reporting by providing new information to the monitoring node, thereby satisfying a need for area of interest change notification, but, more importantly, the above described method can significantly reduce network load in comparison to tracking area (or routing area) level reporting because the monitoring node can specify any geographic area including a geographic area that encompass many TAs/RAs.

In some embodiments, generating the PRAT comprises selecting, based on the GM, at least a first area identifier to include in the set of area identifiers. The selected first area identifier may identify an area that overlaps with at least portion of the geographic area specified by the GM. In some embodiments, the first area identifier is one of: a cell identifier that identifies a cell of a communication network, a base station identifier that identifies a base station of the communication network, a tracking area identifier identifying a tracking area of the communication network, a routing area identifier identifying a routing area of the communication network.

In some embodiments, the method also includes: receiving a message transmitted by the subscriber data function, wherein the message comprises a presence reporting area, PRA, status value, wherein the PRA status value specifies that: i) a UE identified by the ID is located within the PRA, ii) a UE identified by the ID is not located within the PRA, or iii) the PRA is inactive, and in response to receiving the message, transmitting to the monitoring node a message that comprises the received PRA status value.

In some embodiments, the method also includes receiving a reporting message transmitted by a mobility function as a result of the mobility function detecting that a UE identified by the ID has either moved into the PRA or moved out of the PRA, or the PRA is inactive, wherein the message comprises a UE identifier that identifies the UE and a PRA status value. In such an embodiment, the method may also include, in response to receiving the reporting message transmitted by the mobility function, transmitting to the monitoring node a message comprising information indicating one of: the UE has moved into the geographic area, GA, defined by the GM, the UE has moved out of the GA, and inactive PRA.

In some embodiments, the GM comprises: a type value indicating a shape type and information describing the shape, the information comprising a latitude value and a longitude value, or the GM comprises civic address information.

In some embodiments, the method further includes the subscriber data function receiving the second request message, wherein the second request message is transmitted by an exposure function; and, in response to receiving the second request message, the subscriber data function transmitting a configuration message to a mobility function, the configuration message comprising the PRAT and a UE ID identifying a UE identified by the ID (e.g., in the case where the ID identifies a group of UE, the UE ID is a UE ID for a UE included in the group of UEs; and in the case where the ID identifies a single UE, the UE ID is an ID for the single UE). In such an embodiment, the method may also include the subscriber data function receiving an answer message transmitted by the mobility function in response to the configuration message, wherein the answer message comprises a PRA status value; and the subscriber data function transmitting to the exposure function a message comprising the PRA status value received from the mobility function.

### BRIEF DESCRIPTION OF THE DRAWINGS

The accompanying drawings, which are incorporated herein and form part of the specification, illustrate various embodiments.

FIG. 1 illustrates a communications network according to one embodiment.

FIG. 2 is a flow chart illustrating a process according to one embodiment.

FIG. 3 is a message flow diagram according to one embodiment.

FIG. 4 is a block diagram of a network node according to one embodiment.

FIG. 5 is a diagram showing functional units of a network node according to one embodiment.

### DETAILED DESCRIPTION

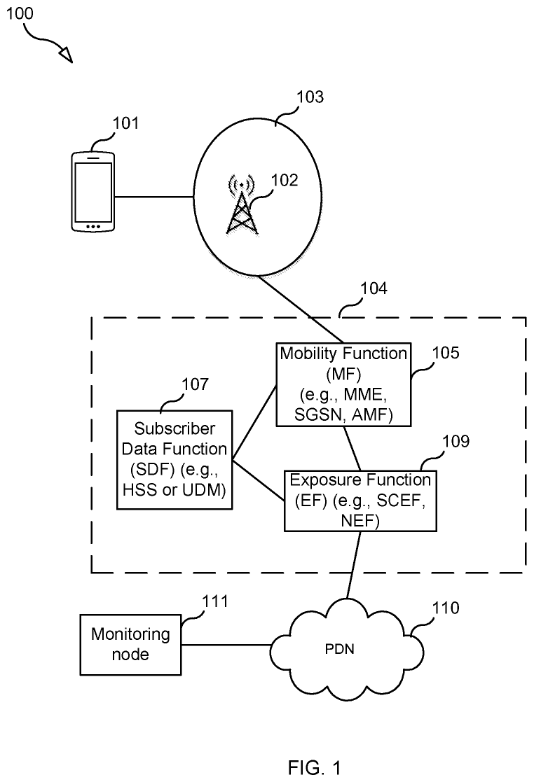

FIG. 1 illustrates a communications network 100 according to one embodiment. More specifically, FIG. 1 illustrates a UE 101 that is connected to an access network 103, which may be a radio access network (RAN). AN 103 includes at least one access point 102 (e.g., a base station or other access point). Access point 102 is connected to a back-end system 104 (e.g., a Long Term Evolution (LTE) Evolved Packet Core (EPC), a 5G Core Network). System 104 includes: a mobility function (MF) 105 (e.g., a 3GPP 4G Mobility Management Entity (MME), a 3GPP 5G Access and Mobility Function (AMF), etc.); a subscriber data function (SDF) 107 for storing and retrieving subscriber information (e.g., a 3GPP 4G Home Subscriber Server (HSS), a 3GPP 5G Unified Data Management (UDM), etc.); and an exposure function (e.g., a 3GPP 5G Network Exposure Function (NEF), a 3GPP 4G SCEF, etc.). As illustrated in FIG. 1, EF 109 may communicate with an external UE monitoring node 111 via a packet data network 110 (e.g. the Internet).

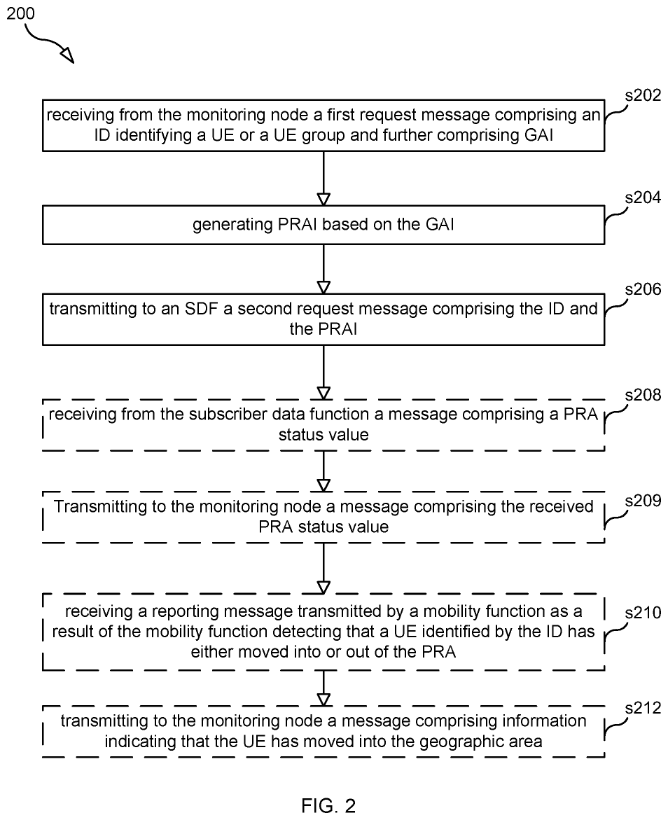

FIG. 2 is flowchart illustrating a process 200, according to an embodiment, for providing UE location information to UE monitoring node 111. Process 200 may begin in step s202.

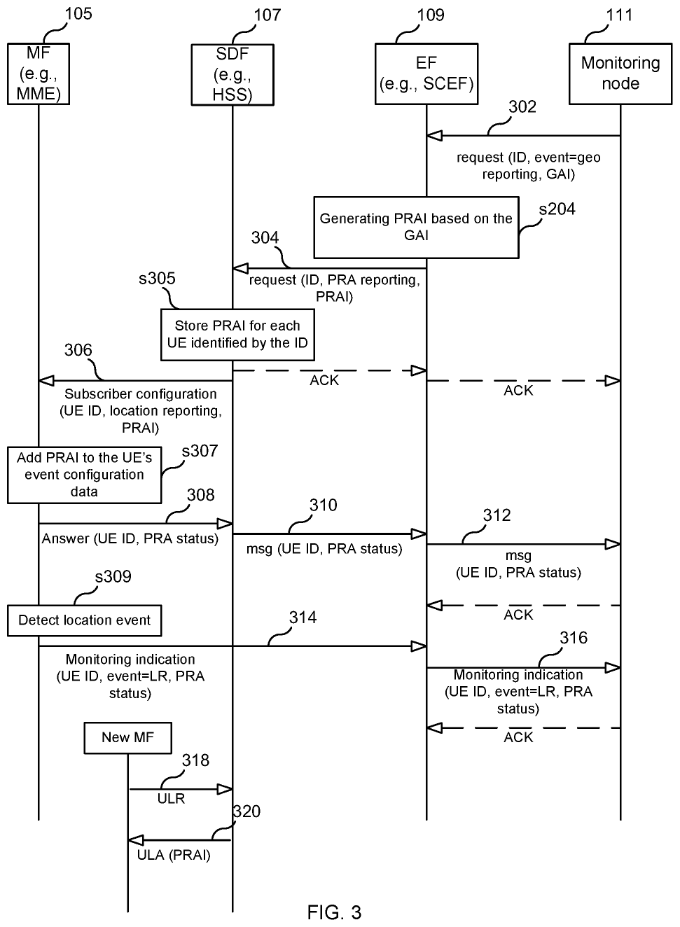

In step s202, exposure function 109 receives a first request message (302) (see FIG. 3) transmitted by monitoring node 111. The first request message 302 comprises an ID identifying either a single user equipment, UE (e.g., UE 101), or a group of UEs (e.g., a group of UEs that includes UE 101). For example, the ID may be an International Mobile Subscriber Identity (IMSI), International Mobile Equipment Identifier (IMEI), Mobile Station International Subscriber Directory Number (MSISDN), or other UE ID that identifies a single UE (e.g., UE 101). The first request message 302 further includes geographic area information (GM) defining a geographic area. In one embodiment, the GAI comprises a type value indicating a shape type and information describing the shape (e.g., a set of one or more latitude values and/or a longitude values). For instance, in such an embodiment the GM may be a bit string encoding a geographical description as defined in section 7 of 3GPP TS 23.032 v 14.1.0. In another embodiment, the GM comprises civic address information. For example, the GM may comprise a country name, a street name, etc. For instance, in such an embodiment, the GM may comprise a “CivicAddress” as defined in section 6.1.6.2.14 of 3GPP TS 29.572 v 1.1.0.

The first request message 302 requests that the monitoring node be provided with a notification when it has been discovered that any UE identified by the ID has moved into (or out of) the geographic area. For example, the first request message 302 is configured to cause exposure function (EF) 109 to configure a particular location monitoring event so monitoring node 111 will notified when it is discovered that a UE identified by the ID has moved into (or out of) the geographic area. EF 109 may configure the monitoring event by transmitting message 304 to SDF 107, which then configures mobility function (MF) 105 to provide to monitoring node 111 a notification when it discovers that a UE identified by the ID has moved into (or out of) the geographic area. That is, SDF 107 establishes the particular location monitoring event in MF 105. SDF 107 accomplishes this by transmitting a configuration message 306 to MF 105.

First request message 302 may be a request message that includes one or more of the parameters that may be included in a Monitoring Request as specified in section 5.6.1.1 of 3GPP TS 23.682 v 15.4.0 (“TS 23.682”) as well as including the GM. For instance, message 302 may include the ID, the GAI, as well as an SCS/AS Identifier, a transaction identifier (e.g., T8 Transaction Reference ID (TTRI)), a long term transaction identifier (e.g., T8 Long Term Transaction Reference ID (TLTRI)), Monitoring Type, Maximum Number of Reports, Monitoring Duration, T8 Destination Address, TLTRI for Deletion, Group Reporting Guard Time, all of which are described in TS 23.682. In this example, the monitoring type may be set to a particular value (e.g., “geographic reporting”) that provides an indication that monitoring node is requesting to be notified whenever MF 105 (or other MF) has discovered that any UE identified by the ID has moved into (or out of) the geographic area.

In response to receiving the first request message, exposure function performs steps s204 and s206.

In step s204, exposure function 109 generates presence reporting area information (PRAT) based on the GM. In one embodiment, exposure function 109 generates the PRAT by performing steps that include selecting, based on the GM, at least a first area identifier to include in the set of area identifiers. The selected first area identifier identifies an area that overlaps with at least portion of the geographic area specified by the GAI. The first area identifier may be one of: a cell identifier that identifies a cell of a communication network, a base station identifier that identifies a base station of the communication network, a tracking area identifier identifying a tracking area of the communication network, a routing area identifier identifying a routing area of the communication network. In some embodiments, the PRAT comprises or consists of a Presence-Reporting-Area-Elements-List AVP, an example of which is defined in section 5.3.107 of 3GPP TS 29.212 v 15.2.0 (“TS 29.212”).

In step s206, exposure function 109 transmits to subscriber data function 107 a second request message 304 comprising the ID and the PRAT. For example, the second request message 304 may include a Presence-Reporting-Area-Information AVP that comprises the PRAI. The Presence-Reporting-Area-Information (PRAI) AVP is currently defined in section 5.3.109 of TS 29.212.

Second request message 304 may be a request message that includes one or more of the parameters that may be included in a Monitoring Request as specified in section 5.6.1.1 of 3GPP TS 23.682 v 15.4.0 (“TS 23.682”) as well as including the PRAT (e.g., a PRAT AVP comprising the PRAI). For instance, message 304 may include the ID, the PRAT, as well as one or more of SCEF ID, Monitoring Type, Monitoring Duration. In this example, the monitoring type may be set to a particular value (e.g., “geographic reporting”) that provides an indication a monitoring node is requesting to be notified whenever MF 105 (or other MF) has discovered that any UE identified by the ID has moved into (or out of) the geographic area. More specifically, in some embodiments, the second request message is a Configuration-Information-Request (CIR) command defined in section 8.2.3 of 3GPP 29.336 v 15.2.0 (“TS 29.336”) that comprises a Monitoring-Event-Configuration AVP that comprises the PRAI.

In some embodiments, process 200 further includes the subscriber data function 107, in response to receiving the second request message 304, transmitting a configuration message 306 to a mobility function 105, where the configuration message comprises the PRAT and a UE ID identifying a UE identified by the ID. For example, in the case where the ID included in message 304 identifies a group of UEs, the UE ID included in message 306 is a UE ID for one of the UEs included in the group of UEs. Moreover, even though it is not shown in the message flow diagram shown in FIG. 3, for each different UE included in the group of UEs, subscriber data function transmits to a mobility function a message comprising a UE ID for identifying the UE and the PRAI. In the case where the ID included in message 304 identifies a single UE, then the UE ID included in message 306 identifies the single UE. In such a scenario the UE ID included in message 306 may be same ID that is included in message 304. In some embodiments, the message 306 transmitted to the mobility function 105 comprises a PRAI AVP that comprises the PRAI that was generated by exposure function 109. In some embodiments, message 306 includes the PRAI AVP as well as information that may be included in the Insert-Subscriber-Data-Request (IDR) command defined in section 7.2.9 of 3GPP TS 29.272 v 15.3.0 (“TS 29.272”). For example, message 306 may include a subscription data AVP that contains the PRAI AVP.

Additionally, in some embodiments, in response to receiving message 304, subscriber data function 107 stores the PRAI such that it is associated with each UE identified by the ID included message 304 (step s305) (see FIG. 3). That is, subscriber data function 107 stores, for each UE identified by the ID included in message 304, information linking a UE ID for the UE with the PRAI such that when the subscriber data function 107 receives a request for UE information for the UE, the subscriber data function 107 can use the UE ID for the UE to retrieve the PRAT.

In some embodiments, as further shown in FIG. 3, after mobility function (MF) 105 receives message 306, MF 105 adds to event configuration data for the UE identified by the UE ID the PRAI included in the received message 306 (step s307) and transmits to subscriber data function (SDF) 107 a message 308 (e.g., an answer message). In this example, message 308 comprises a PRA status value, and SDF 107, in response to receiving message 308, transmits to exposure function 109 a message 310 comprising the PRA status value received from the mobility function 105. In this example, the PRA status value specifies that: i) a UE identified by the ID is located within the PRA, ii) a UE identified by the ID is not located within the PRA, or iii) the PRA is inactive. In some embodiments, message 308 includes the PRA status value as well as information that may be included in the Insert-Subscriber-Data-Answer (IDA) command defined in section 7.2.10 of TS 29.272. For example, message 308 may include a Monitoring-Event-Report AVP that further contains the PRA status value. Similarly, message 310, in some embodiments, includes the PRA status value as well as information included in the Monitoring Response or Monitoring Indication described in step 8 of section 5.6.1.1 of TS 23.682. For example, in some embodiments, message 310 is a Reporting-Information-Request (RIR) command defined in section 8.2.5 of TS 29.336 that comprises a Monitoring-Event-Report AVP that further comprises the PRA status value.

Accordingly, in some embodiments, process 200 further includes exposure function 109 receiving message 310 transmitted by the subscriber data function 107, wherein the message comprises the PRA status value, wherein the PRA status value specifies that: i) a UE identified by the ID is located within the PRA, ii) a UE identified by the ID is not located within the PRA, or iii) the PRA is inactive. In response to receiving message 310, exposure function 109, transmits to monitoring node 111 a message 312 comprising the UE ID and the PRA status value that was contained in message 310, thereby providing a UE location report to monitoring node 111.

Message 312 may be a message that includes one or more of the parameters that may be included in a Monitoring Response or a Monitoring Indication as specified in section 5.6.1.1 of TS 23.682 as well as including the PRA status value. For instance, message 312 may include a T8 Transaction Reference ID (TTRI) and an event report (e.g., a “Monitoring Event Report”) that includes the PRA status value.

In some embodiments, process 200 further includes exposure function 109 receiving (step s210) a message 314 (a.k.a., “reporting” message 314) transmitted by mobility function 105 as a result of, for example, the mobility function detecting (see step s309) that a UE identified by the ID has either moved into the PRA or moved out of the PRA, or PRA is inactive, wherein the message comprises a UE identifier that identifies the UE and a PRA status value. In some embodiments, reporting message 314 includes the UE ID and PRA status value as well as information that may be included in the Reporting-Information-Request (RIR) command defined in section 6.2.5 of 3GPP TS 29.128 v 15.2.0 (“TS 29.128”). For example, message 314 may include a Monitoring-Event-Report AVP that further contains the PRA status value.

In some embodiments, in response to receiving message 314 transmitted by the mobility function 105, exposure function 109 transmits (step s212) to the monitoring node a message 316 comprising information indicating that the UE has moved into the geographic area, GA, defined by the GAI or moved out of the GA, or UE location is unknown due to inactive PRA. In this manner, UE location information can be provided to UE monitoring node 111. For example, in some embodiments, message 316 may be a message that includes one or more of the parameters that may be included in the Monitoring Indication as described in step 3a of section 5.6.3.1 of TS 23.682 as well as including the PRA status value. For instance, message 316 may include a TTRI, a TLTRI, a cause code, and an event report (e.g., a “Monitoring Event Report”) that includes the PRA status value.

It is possible that a UE identified by the ID included in message 304 may move into a new area served by a new MF 399, shown in FIG. 3. As a result, new MF 399 may transmit to SDF 107 a message 318 (e.g., an Update Location Request (ULR) message defined in TS 29.272) comprising a UE ID and requesting UE information pertaining to the UE identified by the UE ID included in message 318. In response to message 318, SDF 107 uses the UE ID to obtain from a data repository UE information linked to the UE ID, which obtained UE information includes the PRAI that was included in message 304, and SDF 107 transmits to new MF399 a message 320 that comprises the PRAI included in the obtained UE information. As an example, message 320 may be an Update Location Answer (ULA) message defined in TS 29.272 that comprises a subscription data AVP (e.g., the Subscription-Data AVP defined in TS 29.272) that contains, among other things, a monitoring event configuration AVP that contains the PRAI.

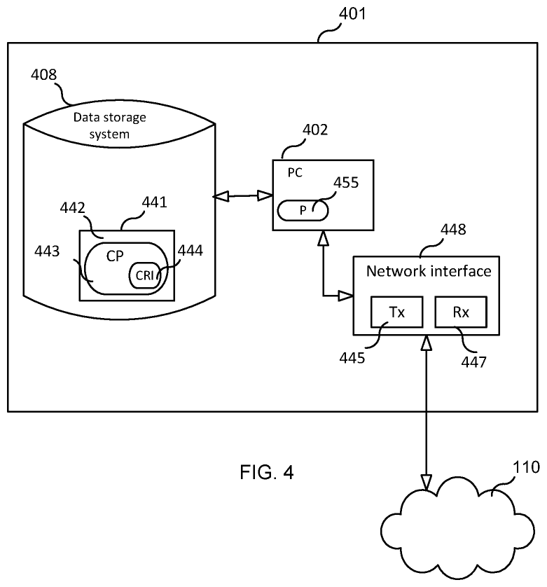

FIG. 4 is a block diagram of network node 401 for implementing exposure function 109 and/or subscriber data function 107, according to some embodiments. As shown in FIG. 4, network node 401 may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like), which processors may be co-located in a single housing or data center or may be geographically distributed; a network interface 448 comprising a transmitter (Tx) 445 and a receiver (Rx) 447 for enabling network node 401 to transmit data to and receive data from other nodes connected to a network 110 (e.g., an Internet Protocol (IP) network) to which network interface 448 is connected; and a local storage unit (a.k.a., “data storage system”) 408, which may include one or more non-volatile storage devices and/or one or more volatile storage devices. In embodiments where PC 402 includes a programmable processor, a computer program product (CPP) 441 may be provided. CPP 441 includes a computer readable medium (CRM) 442 storing a computer program (CP) 443 comprising computer readable instructions (CRI) 444. CRM 442 may be a non-transitory computer readable medium, such as, magnetic media (e.g., a hard disk), optical media, memory devices (e.g., random access memory, flash memory), and the like. In some embodiments, the CRI 444 of computer program 443 is configured such that when executed by PC 402, the CRI causes network node 401 to perform steps described herein (e.g., steps described herein with reference to the flow charts). In other embodiments, network node 401 may be configured to perform steps described herein without the need for code. That is, for example, PC 402 may consist merely of one or more ASICs. Hence, the features of the embodiments described herein may be implemented in hardware and/or software.

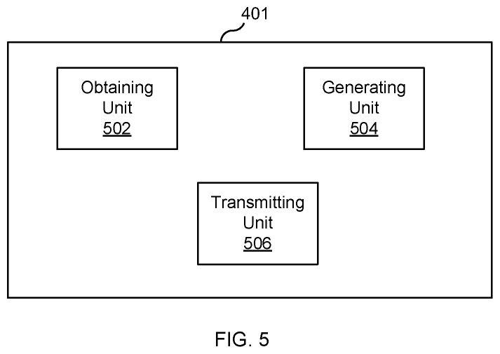

FIG. 5 is a diagram showing functional units of network node 401 according to one embodiment. As shown in FIG. 5, network node 401 includes an obtaining unit 502 for obtaining the first request message 302; a generating unit 504 for generating the PRAI based on the GAI included in message 302; and a transmitting unit 506 for transmitting message 304 to subscriber data function 107.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for providing user equipment (UE) location information to a UE monitoring node, the method comprising:
receiving, at an exposure function, a first request message transmitted by the UE monitoring node, the first request message comprising an identifier, ID, (ID) identifying either a single UE or a group of UEs, and further comprising geographic area information (GAI) defining a geographic area, wherein the first request message requests that the UE monitoring node be provided with a notification when it has been discovered that any UE identified by the ID has moved into or out of the geographic area; and
in response to receiving the first request message:
generating presence reporting area information (PRAI) based on the GAI, wherein the PRAI comprises a set of one or more area identifiers; and
transmitting to a subscriber data function a second request message comprising the ID and the PRAI.

2. The method of claim 1, wherein generating the PRAI comprises selecting, based on the GAI, at least a first area identifier to include in the set of area identifiers.

3. The method of claim 2, wherein the selected first area identifier identifies an area that overlaps with at least portion of the geographic area specified by the GAI.

4. The method of claim 3, wherein the first area identifier is one of: a cell identifier that identifies a cell of a communication network, a base station identifier that identifies a base station of the communication network, a tracking area identifier identifying a tracking area of the communication network, a routing area identifier identifying a routing area of the communication network.

5. The method of claim 1, wherein the method further comprises:
receiving a message transmitted by the subscriber data function, wherein the message comprises a presence reporting area, PRA, status value, wherein the PRA status value specifies that: i) a UE identified by the ID is located within the PRA, ii) a UE identified by the ID is not located within the PRA, or iii) the PRA is inactive, and
in response to receiving the message, transmitting to the UE monitoring node a message that comprises the received PRA status value.

6. The method of claim 1, wherein
the method further comprises receiving a reporting message transmitted by a mobility function as a result of the mobility function detecting that a UE identified by the ID has either moved into the PRA or moved out of the PRA, or the PRA is inactive, wherein the message comprises a UE identifier that identifies the UE and a PRA status value.

7. The method of claim 6, further comprising, in response to receiving the reporting message transmitted by the mobility function, transmitting to the UE monitoring node a message comprising information indicating one of: the UE has moved into the geographic area (GA) defined by the GAI, the UE has moved out of the GA, and inactive PRA.

8. The method of claim 1, wherein
the GAI comprises: a type value indicating a shape type and information describing the shape, the information comprising a latitude value and a longitude value, or
the GAI comprises civic address information.

9. The method of claim 1, further comprising:
the subscriber data function receiving the second request message, wherein the second request message is transmitted by an exposure function; and
in response to receiving the second request message, the subscriber data function transmitting a configuration message to a mobility function, the configuration message comprising the PRAI and a UE ID identifying a UE identified by the ID.

10. The method of claim 9, further comprising:
the subscriber data function receiving an answer message transmitted by the mobility function in response to the configuration message, wherein the answer message comprises a PRA status value; and
the subscriber data function transmitting to the exposure function a message comprising the PRA status value received from the mobility function.

11. A network node for providing user equipment, UE, (UE) location information to a UE monitoring node, the network node comprising:
a memory;
processing circuitry coupled to the memory;
a receiver, coupled to the processing circuitry, that is operable to receive a first request message transmitted by the UE monitoring node, the first request message comprising an identifier (ID) identifying either a single UE or a group of UEs, and further comprising geographic area information (GAI) defining a geographic area, wherein the first request message requests that the UE monitoring node be provided with a notification when it has been discovered that any UE identified by the ID has moved into or out of the geographic area wherein the network node is configured to:
in response to receiving the first request message:
generate presence reporting area information (PRAI) based on the GAI, wherein the PRAI comprises a set of one or more area identifiers; and
transmit to a subscriber data function a second request message comprising the ID and the PRAI.

12. (canceled)

13. The network node of claim 11, wherein generating the PRAI comprises selecting, based on the GAI, at least a first area identifier to include in the set of area identifiers.

14. The network node of claim 13, wherein the selected first area identifier identifies an area that overlaps with at least portion of the geographic area specified by the GAI.

15. The network node of claim 14, wherein the first area identifier is one of: a cell identifier that identifies a cell of a communication network, a base station identifier that identifies a base station of the communication network, a tracking area identifier identifying a tracking area of the communication network, a routing area identifier identifying a routing area of the communication network.

16. The network node of claim 11, wherein the network node is further configured to:
receive a message transmitted by the subscriber data function, wherein the message comprises a presence reporting area, PRA, status value, wherein the PRA status value specifies that: i) a UE identified by the ID is located within the PRA, ii) a UE identified by the ID is not located within the PRA, or iii) the PRA is inactive, and
in response to receiving the message, transmit to the UE monitoring node a message that comprises the received PRA status value.

17. The network node of claim 11, wherein the network node is further configured to receive a reporting message transmitted by a mobility function as a result of the mobility function detecting that a UE identified by the ID has either moved into the PRA or moved out of the PRA, or the PRA is inactive, wherein the message comprises a UE identifier that identifies the UE and a PRA status value.

18. The network node of claim 17, wherein the network node is further configured such that, in response to receiving the reporting message transmitted by the mobility function, the network node transmits to the UE monitoring node a message comprising information indicating one of: the UE has moved into the geographic area (GA) defined by the GAI, the UE has moved out of the GA, and inactive PRA.

19. The network node of claim 11, wherein
the GAI comprises: a type value indicating a shape type and information describing the shape, the information comprising a latitude value and a longitude value, or
the GAI comprises civic address information.

20. A computer program product comprising a non-transitory computer readable medium storing a computer program comprising instructions which when executed on at least one processor causes the at least one processor to carry out the method of claim 1.

21. (canceled)
